(19) United States
(12) Patent Application Publication
(10) Pub. No.: US 2009/0181614 A1
(43) Pub. Date: Jul. 16, 2009

(54) Method and system for providing playback of digital audio content available through a computer network

(76) Inventors: Nicolas Wolff, New York, NY (US); Erik Schwartz, Bath, ME (US)

Correspondence Address: Kevin M. Farrell;Pierce Atwood, Suite 350, One New Hampshire Avenue, Portsmouth, NH, 03801, US

(21) Appl. No.: 12/008,849

(22) Filed: Jan. 15, 2008

(51) Int. Cl. H04H 20/00

(52) U.S. Cl. 455/3.06

(57) ABSTRACT

The present invention comprises a computer-implemented method for providing audio content to mobile devices via a simple, efficient telephony-based system that delivers on-demand playback to a mobile device. The present invention dynamically allocates separate and unique direct inward dialing (DID) numbers to unique combinations of identifiable user-specific mobile devices and specific pieces of audio content such that a user receives a uniquely allocated DID number at the mobile device that links to a specific piece of stored audio content. Calling a DID number enables playback of the associated specific piece of stored audio content to an identifiable user-specific mobile device. A user may call the DID number conveniently at any time and hear playback of the stored audio content without having to first select from a series menu to identify and initiate playback of the piece of stored audio content.

### BACKGROUND OF THE INVENTION

1. Field of the Invention

The present invention relates generally to the field of providing playback of audio content to listening devices, and more particularly, this invention relates to providing a system of dynamically allocating unique direct inward dialing numbers that directly link uniquely identifiable requesting devices to specific pieces of stored audio content for automated playback of the specific pieces of stored audio content.

2. Discussion of Background Information

Audio communication is the single most popular channel for distributing information around the world. Some audio content providers have taken steps to provide audio content downloadable from Internet sites to desktop computers and other devices capable of downloading and storing audio content for subsequent playback.

For example, .mp3 players are ubiquitous devices that play music and other audio content, such as podcasts. Podcasts represent a popular web-based audio medium designed for distributing typically short, time-sensitive audio segments, such as 5 to 10 minute long news segments. Through a link to a Really Simple Syndication (RSS) feed established by a content provider and usually in exchange for a fee, a user may download a podcast to a desktop computer. The user then either may listen to the podcast through the desktop computer, or the user may download the content from a desktop computer to a mobile device compatible with storing and playing such content. Podcasts thus are an excellent means for distributing information, such as news and entertainment audio content, to mobile devices, but playing these podcasts generally requires acquisition of a mobile device capable of running client side software that executes playback of downloaded content stored locally on the mobile device. Furthermore, acquiring such audio content from an RSS feed requires separate steps for proactively downloading content and then initiating playback.

Some services have attempted to provide digital audio content to a ubiquitous mobile device, the cellular telephone. Most of these services, however, require substantial action by a user to initiate playback of specific audio content, and these services fail to provide audio content on demand. For example, one service assigns a single phone number to a podcast such that every user may call that one phone number to hear the associated podcast. This service requires a user to access the Internet over a computer network, enter a website, and search for a particular podcast and associated dial-in-number. The service provides no real time updates to mobile devices and fails to push the dial-in-number out to mobile devices. Other services require a user to first dial in to a user-specific account and navigate a menu to select audio content and initiate playback. None of these existing systems provide automated, on-demand updates and automatic playback of digital audio content to mobile device users.

For these reasons, a need exists for transforming the radio industry from a broadcast model in which everyone receives exactly the same programming at the same time to a narrowcast model where each listener receives the exactly desired programming at a desired time. A needs to provide on-demand playback of audio content to mobile devices through a simple mechanism requiring no separate software application and requiring no download of audio content and subsequent execution of device-side software.

### SUMMARY OF THE INVENTION

The present invention is directed to a system and method for providing audio content to mobile devices and providing a simple, efficient system and method that deliver on-demand playback to a mobile device while requiring no significant effort on the part of a mobile device user to initiate playback.

In one embodiment, the present invention provides a computer implemented method for providing playback of audio content to one or more mobile telephone users comprising first providing a registry in communication with a computer network for receiving and storing user criteria for the one or more mobile telephone users, the user criteria comprising at least a mobile telephone number and a request for a piece of audio content. In a second step, the method of the present embodiment comprises providing a searchable storage repository also in communication with the computer network for receiving and storing a plurality of pieces of audio content for distribution to the one or more registered mobile telephone users. In a next step, the method comprises providing a telephony server also in communication with the computer network that comprises a memory portion and a processor portion, wherein the memory portion contains therein a plurality of dynamically assigned direct inward dialing numbers and a software portion comprising steps executable by the processor. The executable software steps comprise identifying a requested piece of audio content on the searchable storage repository, and establishing a conduit to one of the corresponding pieces of audio content by cross referencing an available dynamically allocated direct inward dialing number terminating at the telephony server with both a requested piece of audio content and a requesting mobile telephone number.

The method also comprises steps for receiving a request at the registry from a mobile telephone user for a specific piece of audio content and assigning a dynamically allocated direct inward dialing number that terminates at the telephony server and uniquely identifies the combination of the requested piece of audio content and the requesting telephone number. Finally, the method of the present embodiment comprises text messaging the dynamically allocated direct inward dialing number to the registered mobile telephone user so that the registered mobile telephone user may call the dynamically assigned direct inward dialing number directly and listen to the requested piece of audio content.

In another embodiment, the present invention comprises a method of using an electronic system for providing audio content to a recipient device, comprising logging in from a user terminal to an electronic registry stored on a service terminal in communication with a computer network also in communication with the user terminal and requesting particular audio content stored in a searchable repository such that the request stores to the registry along with an associated identifier for the recipient device. The method then comprises receiving a text message at the recipient device comprising to a unique dynamically allocated direct inward dialing number that provides a conduit directly to the requested audio content, and calling the number from the recipient device to initiate automatic playback of the requested audio content.

In yet another embodiment, the present invention comprises a method establishing audio content for distribution to a plurality of users comprising first accessing an electronic registry stored on a telephony server through a computer network in communication with the telephony server and also in communication with a user terminal. A next step comprises registering a mobile telephone at the telephony server from the user terminal in communication with the telephony server via the computer network. The method then comprises requesting a dynamically allocated direct inward dialing number from the telephony server running an executable software application thereon for identifying available dynamically allocated direct inward dialing numbers and assigning a direct inward dialing number to a combination of a piece of audio content and a mobile telephone number associated with a user requesting that piece of audio content. A user may then enter into the registry one or more recipient telephone numbers to which the telephony server will distribute one or more dynamically allocated direct inward dialing numbers associated with a recorded audio message such that each of the one or more recipient telephone numbers receives a unique dynamically allocated direct inward dialing number associated with their telephone and the recorded audio content. Next, the method comprises calling the dynamically allocated direct inward dialing number upon receipt of a text message at the mobile telephone number, and recording a message that stores to the telephony server for access by the one or more recipient telephone numbers through the one or more corresponding dynamically allocated direct inward dialing numbers. Lastly, the method comprises ending the message such that the telephony server automatically distributes the one or more corresponding dynamically allocated direct inward dialing numbers to the one or more recipient telephone numbers respectively.

In still yet another embodiment, the present invention provides a method for providing playback of audio content to a plurality of mobile telephone users, comprising providing a computerized telephony server which can accept telephone calls made to any of a plurality of direct inward dialing (DID) numbers terminating at the telephony server, storing in an audio repository available to the telephony server a plurality of items of audio content, and associating each DID number separately and uniquely with a unique combination of elements. The unique combination of elements comprises a mobile telephone number associated with one of the plurality of mobile telephone users, and an item of stored audio content and/or a collection of related items of stored audio content.

The method further comprises storing the association of a unique DID to the unique combination in an association repository available to the telephony server and delivering each uniquely associated DID number to the corresponding associated mobile telephone number. Next, the method comprises receiving at the uniquely associated DID number terminating at the telephony server a telephone call from the corresponding associated mobile telephone number, and cross-indexing in the association repository the corresponding associated mobile telephone number from which the associated mobile telephone user is calling with the uniquely associated DID number that the associated mobile telephone user called. Lastly, the method comprises retrieving from the audio repository an item of stored audio content assigned to the uniquely associated DID number, and playing the item of audio content to the associated mobile telephone user.

The present invention also provides a system for playback of audio content to a plurality of mobile telephone users, comprising a repository containing a plurality of items of stored audio content, and a data store in communication with the repository and adapted to associate each of a plurality of direct inward dialing numbers (DIDs) separately and uniquely to each of a plurality mobile telephone numbers corresponding the one or more mobile telephone users, and assign to each DID association an item of stored audio content or a category of items of stored audio content. The system further comprises a computerized device comprising a processor portion, a memory portion and a software portion thereon comprising steps executable by the processor. The executable steps comprise receiving telephone calls from each of the plurality of mobile telephone users on each of a uniquely associated one of the plurality of DIDs, cross-indexing in the data store each of the plurality of mobile telephone numbers from which the each of the plurality of mobile telephone users is calling with each of the plurality of DIDs called, retrieving from the repository the plurality of items of stored audio content assigned to each DID association; and playing the plurality of items of stored audio content to each of the plurality of mobile telephone users over the connected telephone calls to the corresponding uniquely associated DIDs.

### BRIEF DESCRIPTION OF THE DRAWINGS

These and other features, aspects, and advantages of the present invention will become better understood with reference to the following description, appended claims, and accompanying drawings where:

FIG. 1 is a schematic showing an overview of an embodiment of the system of the present invention.

FIG. 2 is a schematic showing an embodiment of a method of the present invention.

FIG. 3 is a schematic of one aspect of the present invention.

FIG. 4 is an exemplary embodiment of a graphical user interface representing one aspect of an embodiment of the present invention.

FIG. 5a is an exemplary embodiment of a graphical user interface representing another aspect of the present invention.

FIG. 5b is an exemplary embodiment of a graphical user interface representing another aspect of the present invention.

FIG. 5c is an exemplary embodiment of a graphical user interface representing another aspect of the present invention.

FIG. 6a is an exemplary embodiment of a graphical user interface representing another aspect of the present invention.

FIG. 6b is an exemplary embodiment of a graphical user interface representing another aspect of the present invention.

FIG. 7 is an exemplary embodiment of a graphical user interface representing another aspect of the present invention.

FIG. 8 is an exemplary embodiment of a graphical user interface representing another aspect of the present invention.

FIG. 9 is an exemplary embodiment of a graphical user interface representing another aspect of the present invention.

FIG. 10 is an exemplary embodiment of a graphical user interface representing another aspect of the present invention.

FIG. 11 is an exemplary embodiment of a graphical user interface representing another aspect of the present invention.

FIG. 12 is an exemplary embodiment of a graphical user interface representing another aspect of the present invention.

FIG. 13 is a schematic showing an embodiment of a method of the present invention.

FIG. 14 is an exemplary embodiment of a graphical user interface representing another aspect of the present invention.

FIG. 15 is an exemplary embodiment of a graphical user interface representing another aspect of the present invention.

FIG. 16 is an exemplary embodiment of a graphical user interface representing another aspect of the present invention.

FIG. 17 is an exemplary embodiment of a graphical user interface representing another aspect of the present invention.

FIG. 18 is an exemplary embodiment of a graphical user interface representing another aspect of the present invention.

FIG. 19 is an exemplary embodiment of a graphical user interface representing another aspect of the present invention.

FIG. 20 is an exemplary embodiment of a graphical user interface representing another aspect of the present invention.

### DETAILED DESCRIPTION

The present invention resolves the stated deficiencies of systems and methods for providing audio content to mobile devices, and provides a simple, efficient telephony-based system that delivers on-demand playback to a mobile device adapted to communicate with a telephony server. The present invention requires no significant effort on the part of a mobile device user to initiate playback. The system and method of the present invention dynamically allocate separate and unique direct inward dialing (DID) numbers to separate and unique combinations of identifiable user-specific mobile devices and specific pieces of audio content such that a user receives a uniquely allocated DID number at the mobile device that links to the specifically associated piece of stored audio content. Calling a DID number enables automatic playback of the associated specific piece of stored audio content to an identifiable user-specific mobile device. A user may call the DID number conveniently at any time and hear playback of the stored audio content without having to first select from a series menu to identify and initiate playback of the piece of stored audio content. The present invention requires no downloading of stored audio content, no execution of device-side software for replaying the stored audio content, and thus requires no tailoring of the audio content to suit specific device characteristics. Various features and advantages of the present invention are described below with reference to several preferred embodiments and variations thereof. Those skilled in the art, however, will understand that alternative embodiments of the structures and methods illustrated herein may be employed without departing from the scope and principles of the described invention.

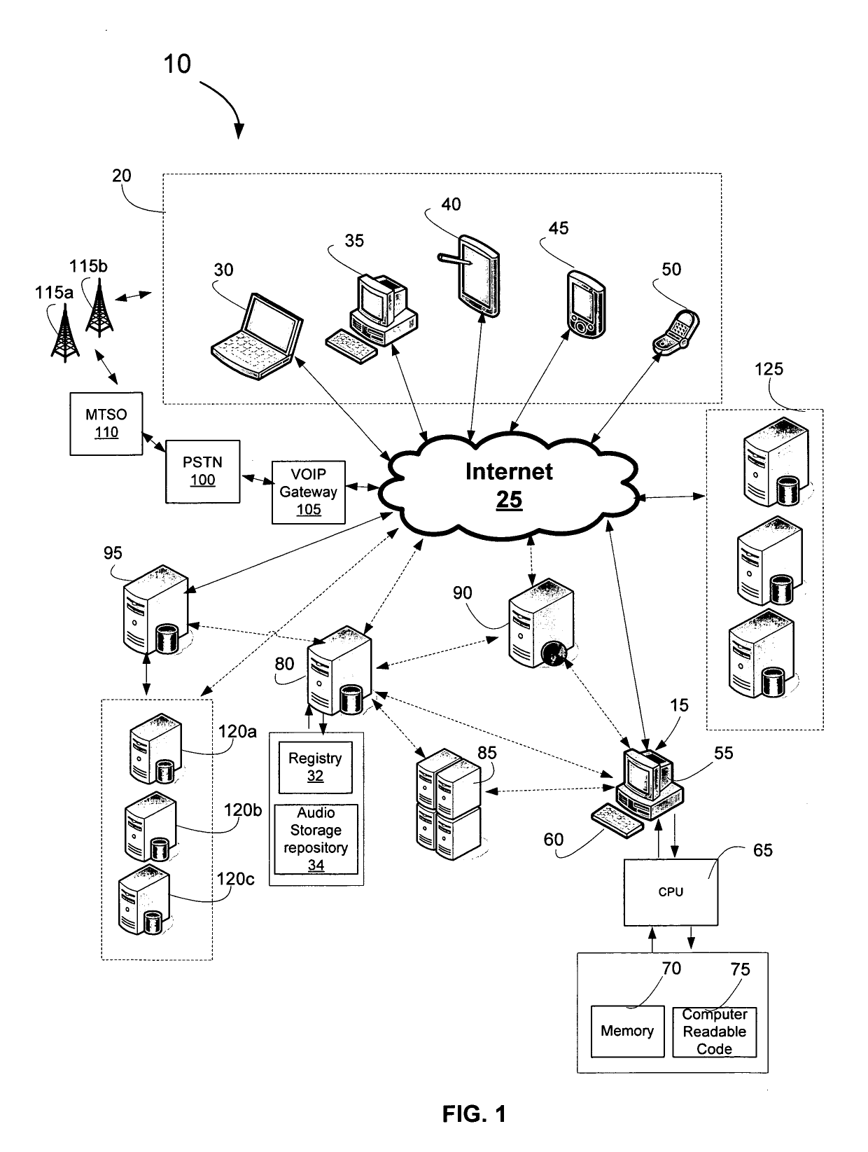

FIG. 1 depicts an overview of the system 10 of the present invention. This system 10 includes an organization terminal 15 in communication with a plurality of user terminals 20 that are communicating through a computer network. Because the present invention is available on a global level, and because the Internet 25 is a global electronic communications network linking private and public networks and computers, the Internet 25 is an appropriate medium for facilitating the present invention. The plurality of user terminals 20 are preferably devices capable of communicating with the Internet 25 through wired or wireless means, devices for example, such as a laptop computer 30, a stationary computer 35, a personal computing device (PCD) 40, a multifunction personal digital assistant 45, such as a Blackberry, and a mobile telephone 50. One or more of the plurality of user terminals 20 may access voice over internet protocol (VoIP) gateways for communicating with other telephony components of the system 10.

The organization terminal 15 is preferably a computer that comprises elements typical of a computing system. These elements include items such as a monitor 55, a keyboard 60, a processor such as a central processing unit (CPU) 65, and a memory storage area 70. For example, the memory storage area 70 may be read only memory (ROM), random access memory (RAM), or a combination of RAM and some removable memory storage means such as floppy disk, EPROMs, PROMs, or USB storage devices. The memory storage area 60 contains thereon computer readable code, or software 75, for executing the present invention. For an added level of security and more expansive storage capacity, in an alternative embodiment, the memory storage area 70 may be a database server 80 also having a processor 65 therein for executing the software 75 stored in the memory storage area 70. Additionally, the database server 80 may store therein a registry 82 for storing user information and a storage repository 84 for storing a plurality of pieces of audio content. In an alternative embodiment, the organization terminal 15 optionally also may communicate with an application server 85 having a memory storage area 70 and a processor 65 that respectively store and execute the software 75, and with a web server 90 that hosts an interactive website that enables user registration from the plurality of user terminals 20.

Bi-directional routers (not shown) also may be disposed between each of the plurality of user terminals 20 and the Internet 25, and between the Internet 25 and the organization terminal 15. Additionally the laptop computer 30, stationary computer 35, PCD 40, Blackberry 45, and mobile telephone 50 are shown by way of example only and an unlimited number of user terminals 20 may communicate with the organization terminal 15.

In a preferred embodiment, the system 10 further comprises a telephony server 95 also in communication with the plurality of user terminals via wired or wireless means. The telephony server also may be in communication with the Internet 25 for connecting to the publicly-switched telephone network (PSTN) 100 via a voice over internet protocol (VoIP) gateway 105. The telephony server 95 thus communicates with the plurality of user terminals via VoIP or some other wired or wireless means such as digital wireless radio frequency, satellite, Bluetooth, and wireless and/or wired local area networks (LANs) and wide area networks (WANs). For example, the telephony server 95 may communicate with a mobile telephone 50 via a mobile telephone switching office (MTSO) in communication with a plurality of cellular base stations 115a, 115b.

The telephony server 95 also may communicate with one or more additional audio storage servers 120a, 120b, 120c also in communication through wired or wireless means and preferably communicating over the Internet 25. Finally, the system comprises a plurality of content provider databases 125 also in communication with the Internet 25. The remainder of the detailed description details interactions between the elements of the system 10 of the present invention.

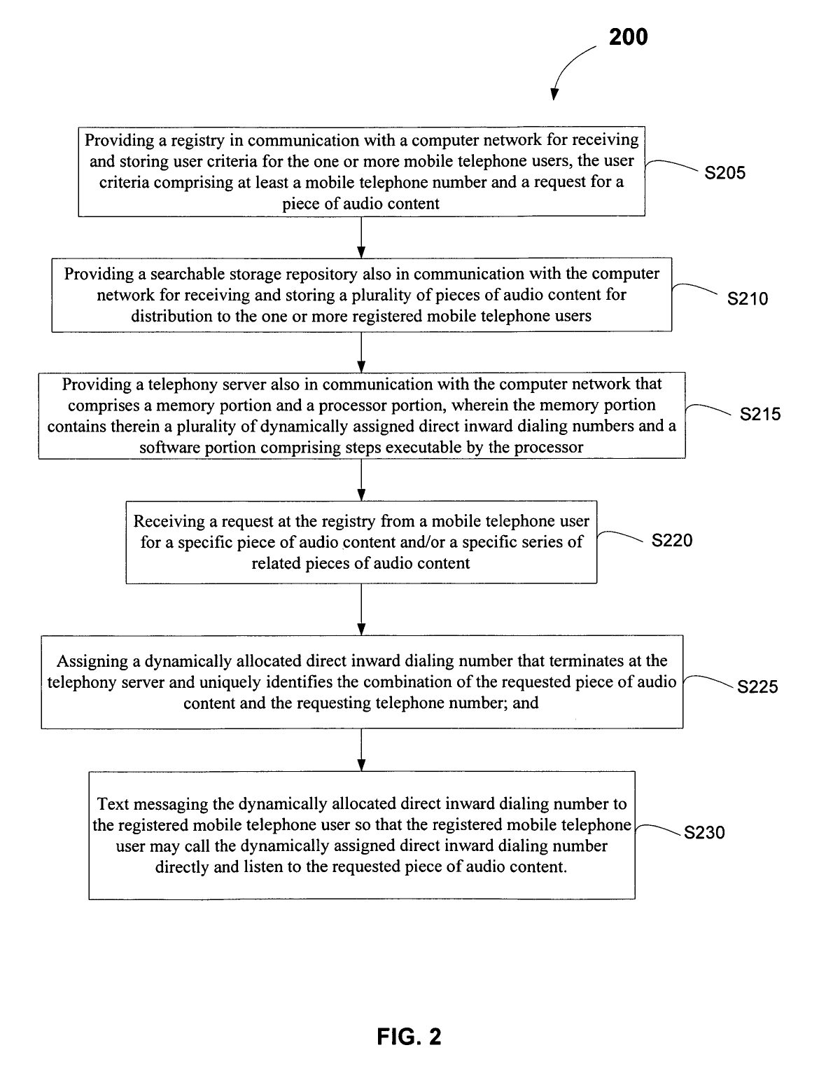

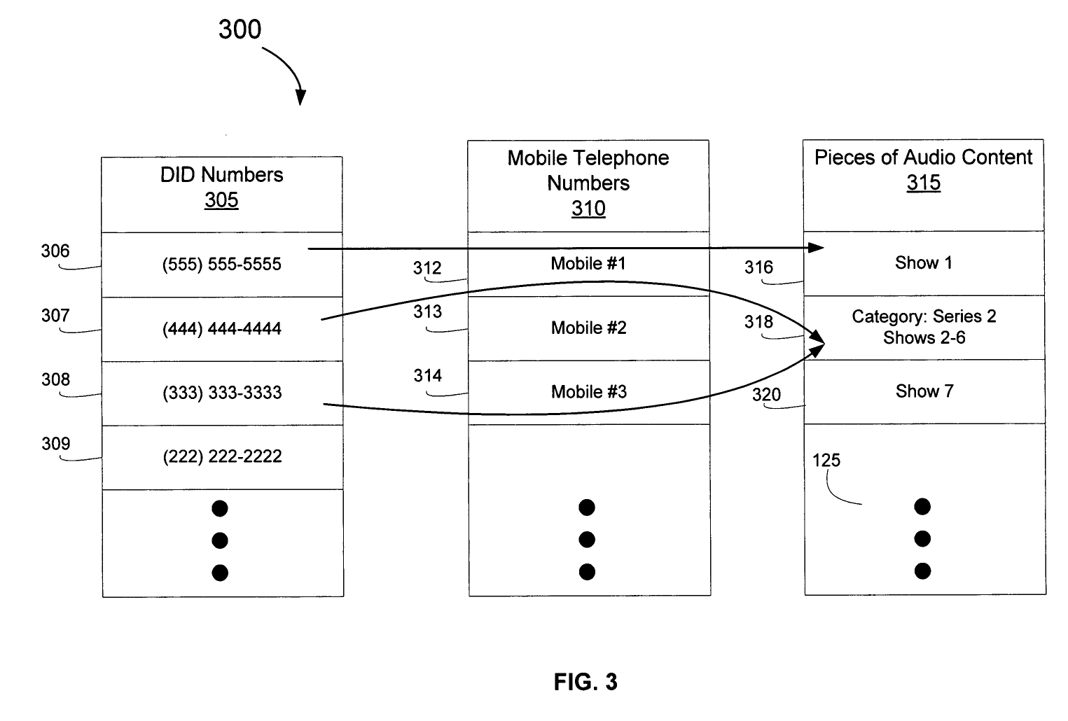

Turning now to FIGS. 2 and 3 together, which respectively depict one embodiment of the computer-implemented method 200 of the present invention for providing playback of audio content to one or more mobile telephones 50 and a schematic of a cross-index 300 representing the dynamic allocation of a plurality of direct inward dialing (DID) numbers 305, a first method step S205 comprises providing a registry 82 in communication with a computer network 25 for receiving and storing user criteria for one or more mobile telephones 50. The user criteria comprises at least a mobile telephone number 310 and a optionally may comprise a request for playback of a piece of audio content 315 and/or a collection of related pieces of audio content 315. A second step S210 comprises providing a searchable storage repository 84 also in communication with the computer network 25 for receiving and storing a plurality of pieces of audio content 315 for distribution to the one or more registered mobile telephones 50. For example, this storage repository 84 may be located on the database server 80 along with the registry 82.

A third step S215 comprises providing a telephony server 95 also in communication with the computer network 25. The telephony server 95, or an organization terminal 15 in communication with the telephony server 95, comprises a memory portion 70 and a processor portion 65, and the memory portion 65 contains therein both a plurality of dynamically assigned direct inward dialing (DID) numbers 305 and a software portion 75 comprising steps executable by the processor 65. The executable steps comprise identifying a requested piece of audio content 315 or a collection of related pieces of audio content 315 on the searchable storage repository 84, and establishing a conduit to one of the corresponding pieces of audio content or collection of related pieces of audio content 315 by cross referencing an available dynamically allocated direct inward dialing number 305 terminating at the telephony server 95 with both a requested piece of audio content 315 and a requesting mobile telephone number 310.

A fourth step S220 comprises receiving a request at the registry from a mobile telephone user for a specific piece of audio content 315 or a collection of related pieces audio content 315, and a fifth step S225 comprises assigning a dynamically allocated DID number 305 that terminates at the telephony server 95 and uniquely identifies the combination of the requested piece of audio content 315 and the requesting telephone number 310. Lastly, the method comprises a final step S230 of text messaging the dynamically allocated direct inward dialing number 305 to the registered mobile telephone 50 so that the registered mobile telephone user may call the dynamically assigned direct inward dialing number 305 directly and listen to the requested piece of audio content 315. The following description addresses these method steps S205-S220 in detail and in reference to additional, descriptive figures.

As FIG. 3 depicts, each of the plurality of DID numbers 305 links to only one combination of one of the plurality of mobile telephone numbers 310 and either one of the plurality of pieces of audio content 315 or one of the collections of related pieces of audio content 315. The plurality of DID numbers 305 terminate at the telephony server 95 which accesses both the registry 82 and the searchable storage repository 84 for providing play back of the plurality of pieces audio content 315 according to the cross-index 300 preferably stored on the registry 82 to which the telephony server 95 may read and write. For example, the software 75 first identifies unassigned DID numbers 305 terminating at the telephony server 95. The executable steps of the software 75 then comprise uniquely assigning the plurality of DID numbers 305 to the unique combinations of mobile telephone numbers 310 and pieces of audio content 315.

In FIG. 3, the software 75 assigns a first unused DID number 306, depicted as “(555) 555-5555,” to a unique combination of a first mobile telephone number 312, “mobile #1,” and a first piece of audio content 316, depicted as “show 1.” When the first mobile telephone number 312 calls the first DID number 306 terminating at the telephony server 95, the telephony server 95 accesses the registry 32 to identify a unique combination of the first mobile telephone number 312 and the first piece of audio content 316 assigned to the combination of the first mobile telephone number 312 and the first DID number 306. All three elements of the combination must be satisfied to initiate playback. The exact one of the plurality of mobile telephone numbers 310 calling the uniquely identified one of the plurality of DID number 305 receives audio play back of the uniquely associated piece of audio content 315. In a preferred embodiment, the telephony server 95 automatically recognizes any of the plurality of mobile telephone numbers 310 through Automatic Number Identification (ANI) or some automated Called Identification (Caller ID) means, and the telephony server 95 automatically accesses the registry 32 to locate the specific piece of audio content 315 assigned to play back over the called DID number 305 to the uniquely identified mobile telephone 50. In the first example of FIG. 3, the first piece of audio content 316 will play back automatically to a mobile telephone 50 uniquely associated with the first mobile telephone number 312.

FIG. 3 demonstrates another key characteristic of the present invention of dynamically allocating the plurality of DID numbers 305 to a collection of pieces of audio content 315. Here, the telephony server 95 has assigned a second DID number 307, depicted as “(444) 444-4444,” to a unique combination of the first mobile telephone number 312 and a second piece of audio content 318, depicted as a collection of related pieces of audio content 315 labeled as “shows 2-6” in a collection labeled “series 2.” For example, shows 2 though 6 may represent audio recapitulations summarizing episodes of a single television series. Comparing this assignment of the second DID number 307 to the assignment of the first DID number 306 highlights another key element of the present invention. Each of the plurality of DID numbers 305 maps to a particular combination of one of the plurality of mobile telephone numbers 310 and one of the plurality of pieces of audio content 315. The first mobile telephone number 312 thus receives access to each of plurality of pieces of audio content 316, 318 over separate and distinct DID numbers 306, 307.

Next, FIG. 3 depicts a third DID number 308, “(333) 333-3333,” uniquely assigned to a unique combination comprising a second mobile telephone number, “mobile #2” and “series 2.” Comparing this assignment with the last assignment demonstrates that more than one of the plurality of mobile telephone numbers 310 may receive audio play back of a series, labeled here as “series 2.” Each of these two mobile telephone numbers 310, however, will receive a unique DID number 305 cross-referencing their unique mobile telephone number 310 with the second piece of audio content 318, a collection of pieces of audio content labeled “series 2.” The tripartite combination of elements is unique for each mobile telephone 50, although both the second mobile telephone number 313 and the first mobile telephone number 312 will receive separate and distinct DID numbers 305 enabling play back of the same, second piece of audio content 318 stored in the searchable storage repository 84. Because each of these two mobile telephone numbers 312, 313 receive unique DID numbers 307, 308, the user of each associated mobile telephone 50 may dial in to the telephony server 95 at their own particular convenience and automatically hear play back of the second piece of audio content 318. The dynamic allocation of DID numbers 305 thus provides flexibility to users of the system 10 of the present invention.

Lastly, FIG. 3 exemplifies a scalable commodity of the system 10 of the present invention, the availability of the plurality of direct inward dialing numbers 305. A limited number of DID numbers 305 may terminate at one or more telephony servers 95 in communication with the system 10 through wired or wireless communication means, such as the Internet 25. The quantity of the plurality of DID numbers 305 is expandable with expansion of the system 10. Because the system comprises a finite number of DID numbers 305, the software 75 first searches for an unassigned, available one of the plurality of DID numbers 305 before separately and distinctly assigning that DID number 305 to a unique combination of one of the plurality of pieces of audio content 315 to one of the plurality of mobile telephone numbers 310.

For example, a fourth DID number 309, depicted as “(222) 222-2222,” remains unassigned in the example cross-referencing index 300 of FIG. 3. A fourth mobile telephone number 314 may be registered with the system 10, and when the fourth mobile telephone number 314 links to one of the plurality of pieces of audio content 315, the software 75 will execute steps whereby the telephony 95 server will identify the first available one of the plurality of DID numbers 305, shown here as the fourth DID number 309. The system 10 of the present invention is designed to reuse the plurality of DID numbers 305 if all are already assigned. The system 10, in particular the telephony server 95 commanded by the software 75, may expire the oldest assigned DID number 305 within the plurality of DID numbers 305 and reassign that oldest DID number 305 to a new unique combination of one of the plurality of mobile telephone numbers 310 and one of the plurality of pieces of audio content 315. Alternatively, the system 10 may reuse the oldest DID number 305 assigned to a particular one of the plurality of mobile telephone numbers 310 such that that particular mobile telephone number 310 receives a DID number 305 already received once before, presumably in connection with an already-listened-to piece of audio content 315. The cross index 300 in the registry 32 also may retain data on whether one of the plurality of pieces of audio content 315 has played over an assigned DID number 305 partially, fully, or not at all. Those indicators may provide additional hierarchical rules for expiring and reusing DID numbers 305. The system 10 of the present invention thus provides a dynamic allocation of the plurality of direct inward dialing numbers 305.

Once the software 75 uniquely assigns one of the plurality of DID numbers 305 from the registry 32 to a unique combination of one of the plurality of mobile telephone numbers 310 and one of the plurality of pieces of audio content 315, the telephony server 95 automatically pushes the uniquely assigned DID number 305 to the corresponding mobile telephone number 310. The mobile telephone 50 associated with the corresponding mobile telephone number 310 receives a message via simple messaging service (SMS), also called a text message. The SMS message comprises an embedded DID number 305, and selecting the embedded DID number 305 automatically dials the telephony server 95. The SMS also may comprise text-based advertisements for paid advertisers. Those advertisements also may remain in the registry 32 for association with the plurality of DID numbers 305 upon delivery of the text message.

Once a user dials a DID number 305 from a mobile telephone 50, playback of the piece of audio content 315 begins automatically. The telephony server 95 receiving a call over the DID number 305 automatically identifies the calling mobile telephone number 310, and cross-indexes that with one of the plurality of pieces of audio content 315 in the searchable storage repository 84 per the instructions in the cross-index 300, which in one embodiment is a dynamic look up table disposed on the registry 82. The piece of audio content 315 may be a single show or a collection of shows whereby the newest show plays back first. Advertisements for other pieces of audio content 315 may play after playback of a show or between shows in a series. A user may select to hear one of these advertised pieces of audio content 315 by “clicking” a prescribed keypad button on their mobile telephone 50.

Throughout playback of a piece of audio content 315, a user may control playback by pressing keypad buttons on their mobile telephone, or in the example of an instant messenger running a telephony-enabled client, the user may press keys on a computer terminal keyboard or keys on a web-enabled mobile device running the instant messenger. Most importantly worth noting is that the present invention requires no intervention or active button pressing on the part of a user to initiate playback. Once a user dials the text messaged DID number 305, playback initiates automatically. The system requires the user neither to download audio content locally nor to navigate a menu to select particular pieces of audio content 315 and initiate playback. The playback controls enable a user to control already-initiated playback of a piece of audio content. In one embodiment, dual-tone multi-frequency (DTMF) commands enable a user to select a help menu, skip back to a previous show in a series of pieces of audio content 315, skip ahead, pause, restart, skip backwards, subscribe to a series of pieces of audio content 315, adjust playback speed, and click on other references.

The playback commands also enable a listener to forward a piece of audio content to a second listener. In one embodiment of the present invention, the second listener also uses a mobile telephone 50 having an associated mobile telephone number 310. When the first listener selects a command to forward the piece of audio content 315 to the second listener, the telephony server 95 writes the entered mobile telephone number 310 of the recipient second listener to the registry 32, and the software 75 commands the registry 32 to link that data to the forwarded piece of audio content 315. The software 75 then assigns a unique DID number 305 to the unique new combination of the mobile telephone number 310 of the second listener and the forwarded piece of audio content 315. When the second listener dials that unique DID number 305 text messaged to the mobile telephone 50 of the second listener, the second listener will hear automatic playback of the forwarded piece of audio content 315. Additionally, the present invention optionally enables the first listener to record a voice message that will store to the searchable storage repository 84 and that will remain linked within the cross-index 300 to the forwarded piece of audio content 315 for playback along with that forwarded piece of audio content 315.

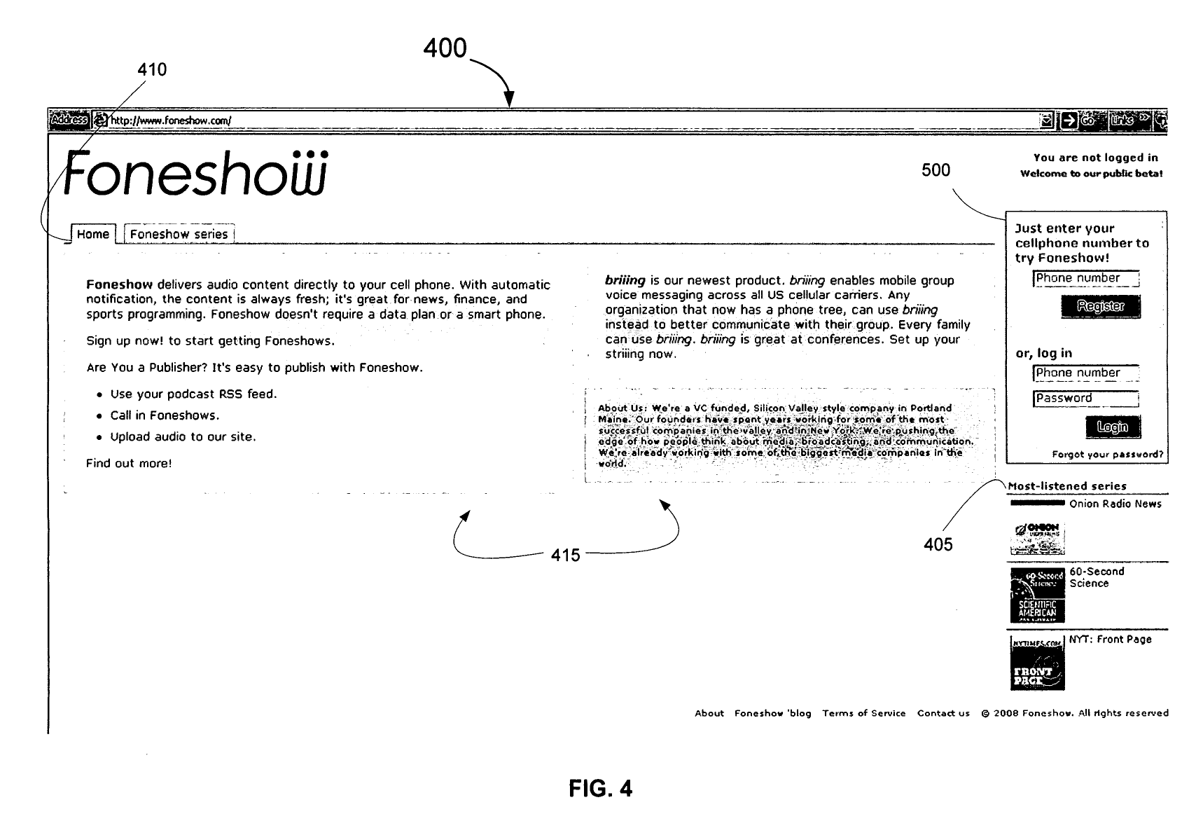

Turning now to FIGS. 4 through 12, the system of the present invention enables a plurality of users of mobile devices, for example mobile telephones 50, to register for automatic and on-demand SMS delivery of DID numbers 305 related to requested pieces of audio content 315. A user may enter a mobile telephone number 310 into the registry 82 through any of the plurality of user terminals 20, and preferably though a user terminal 20 adapted for displaying content available over the Internet 25. As FIG. 4 depicts, the web server 90 hosts a homepage 400 comprising typical elements of a homepage display, such as a user registration and/or log-in block 500, rotating widgets 405, such as a short list of most-listened to series or a short list of most popular series, tabbed pages 410 for easy navigation, text blocks 415 describing operability of the system 10, and hyperlinked text 420 for enabling user interaction with the homepage 400.

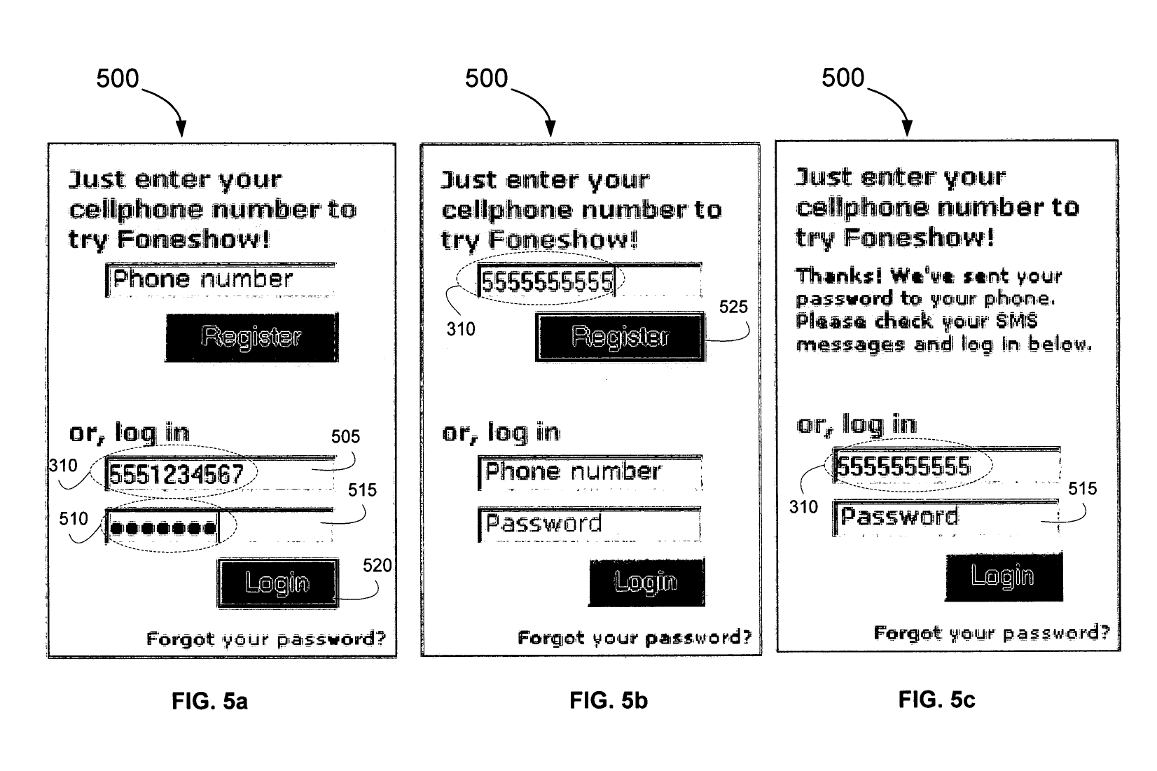

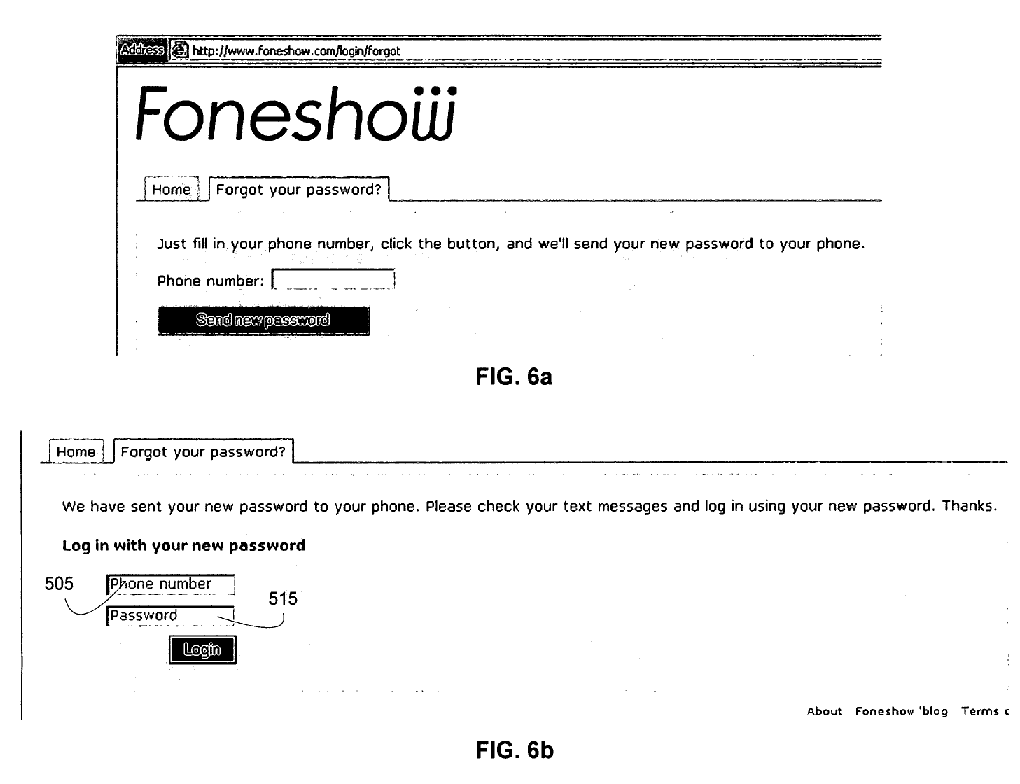

As FIG. 5a depicts, an already-registered user may access elements of the system 10 by entering an already-registered mobile telephone number 310 into a phone number field 505 and a password 510 into a password field 515 and then selecting the login button 520. A new user, by comparison, enters a mobile telephone number 310 into an upper portion of the user registration and/or log-in block and then selects the register button 525 as shown in FIG. 5b. In an alternative embodiment, the web server 90 may automatically recognize a mobile telephone number 310 associated with the plurality of user terminals 20 and automatically populate phone number field 505. In every embodiment, selecting the register button 525 automatically generates a password, and a notification message 530 instructs the user to check for an SMS message on a mobile telephone 50 associated with the entered mobile telephone number 310. The system 10 automatically populates the phone number field 505 with the newly registered telephone number 310, and the user will enter the text messaged password 510 into the password field 515. As FIGS. 6a and 6b depict, the present invention enables users who have forgotten their passwords to request new passwords 510. The system will deliver via text message a new password to a registered user at the mobile telephone 50 associated with the registered mobile telephone number 310.

Worth noting is that other electronic devices may support telephony clients compatible with using the system 10 and method 200 of the present invention. Devices capable of receiving digital audio content, for example as a PDA 410 running an instant messenger equipped with a telephony client, may function to operate within the spirit and scope of the present invention. One skilled in the art will recognize that the references herein to a mobile telephone 50 are by way of example only and that the present invention contemplates uses with other telephony-equipped mobile and stationary devices and systems.

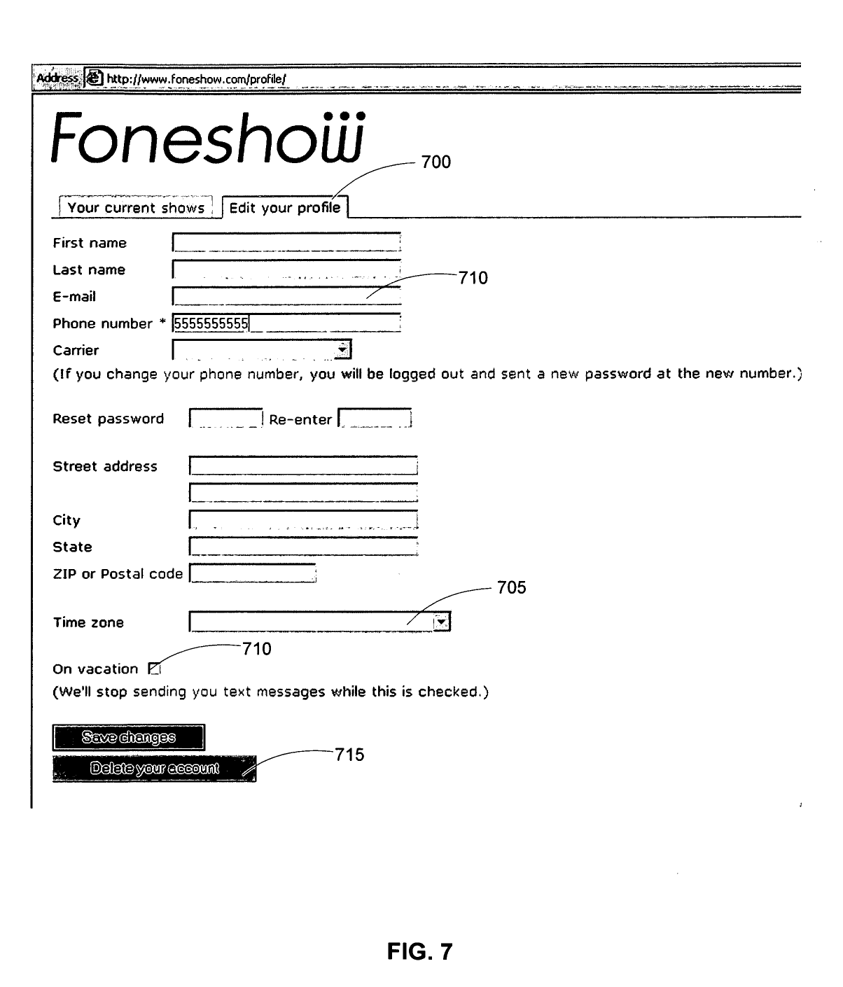

Once logged in, as FIG. 7 shows, a registered user optionally may edit a profile 700 to tailor the system 10 to suit the needs of the particular user. For example, a user may reset the password 510, select a time zone from a time zone pull down menu 705, and select a vacation box 710 to discontinue service until a time when the user desires to unselect the vacation box 710. A user optionally may delete an account simply by selecting a deletion button 715. A user also may enter an email address in an email field 720. This enables the system 10 to provide information, notices and updates regarding the particular piece of audio content 315 and/or services provided by the system 10 of the present invention. Additionally, during playback of a piece of audio content 315, a user may “click” on a message using the DTMF commands and request a comprehensive email message or a reminder regarding a piece of audio content 315. The user criteria, such as the mobile telephone number 310 associated with a mobile telephone 50 and any of these additional pieces of related data, store to the registry 82.

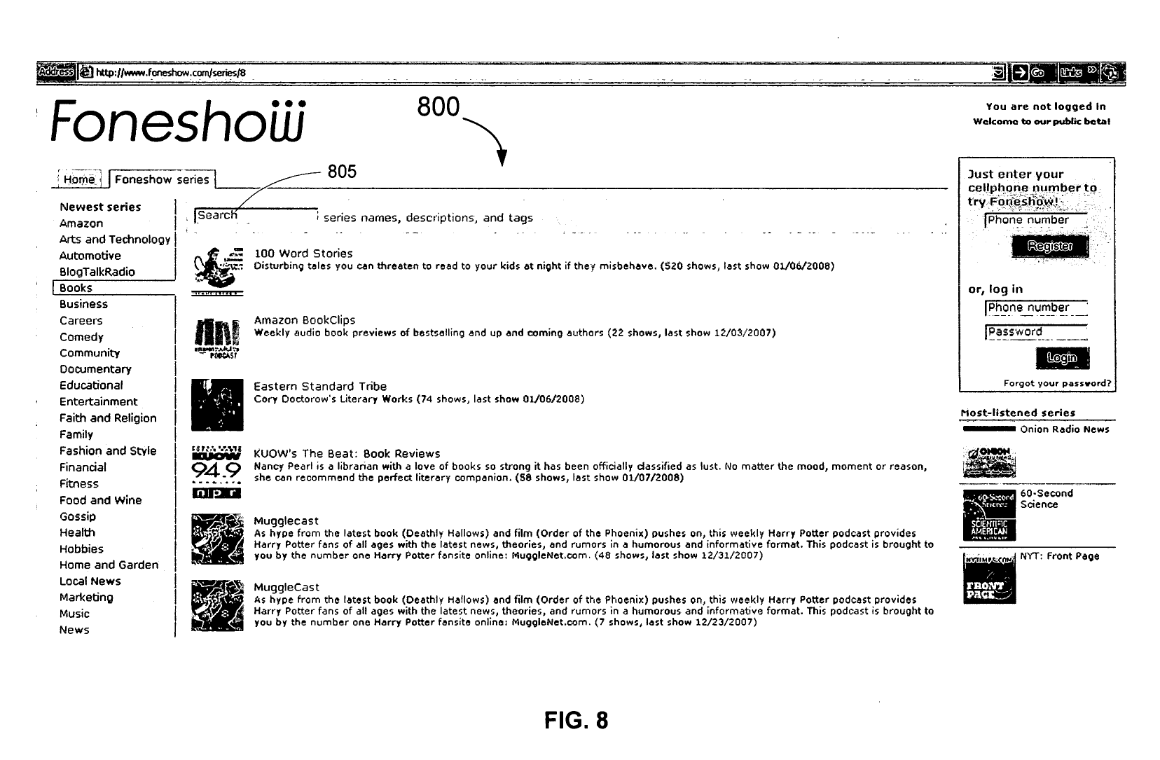

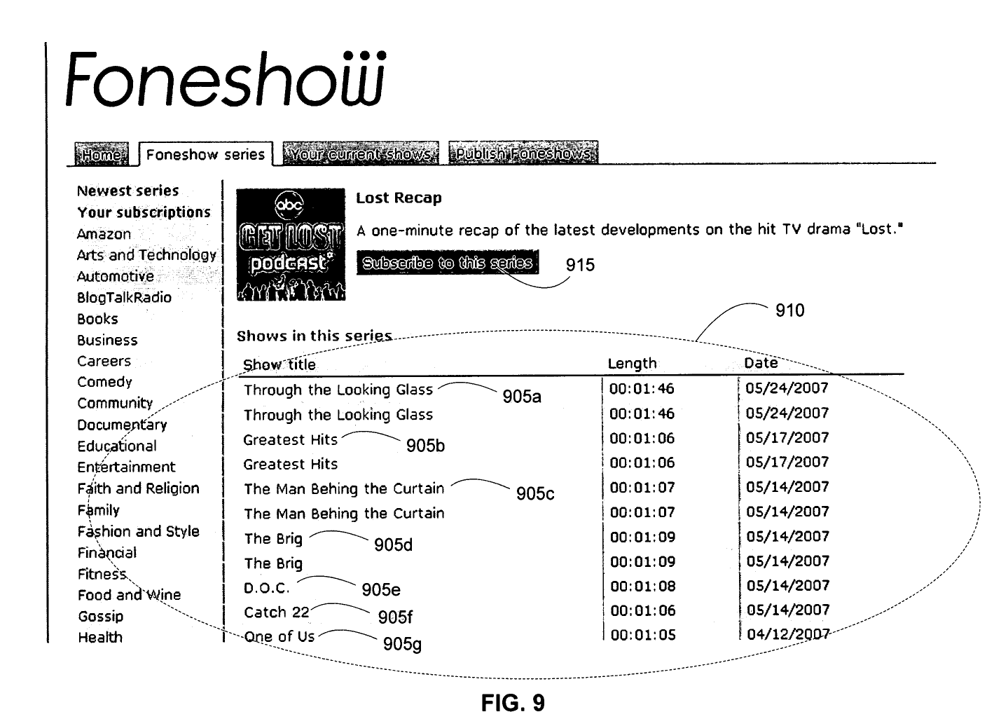

As FIG. 8 shows, a registered user then may access a content listing 800 of the plurality of pieces of audio content 315 stored in the searchable storage repository 84 and adjunct one or more additional audio storage servers 120a, 120b, 120c. A search field 805 enables a user to enter a searchable item of text to identify any of the plurality of pieces of audio content 315 identifiable by that entered text. Once a user locates a desired piece of audio content 315, a show, or collection of pieces of audio content 315, a series, the user may select to hear playback of that series on the registered mobile telephone 50. FIG. 9 depicts a selection of audio content 315. A user may select one or more shows 905a through 905g, or an entire series 910. Each show 905a though 905g in the series 910 comprises hyperlinked text for individual selection of each single show. Selecting a series button 915 enables a user to subscribe to the entire series 910. When a new show 905 in the series 910 stores to the searchable storage repository 84, the software 75 running on the organization terminal 15, application server 85 and/or telephony server 95 pushes a newly assigned DID number 305 to the mobile telephone number 310 of the registered user subscribed to the series 915. The user will hear the newest show in the series 910 first, followed sequentially by older shows 905 in the series 910 and any advertisements selectively played between shows 905. Subscribing to a series 915 thus not only provides delivery of a DID number 305 linking to playback of the outstanding shows 905a through 905g, but the subscription also constitutes a standing, continuous request for new content.

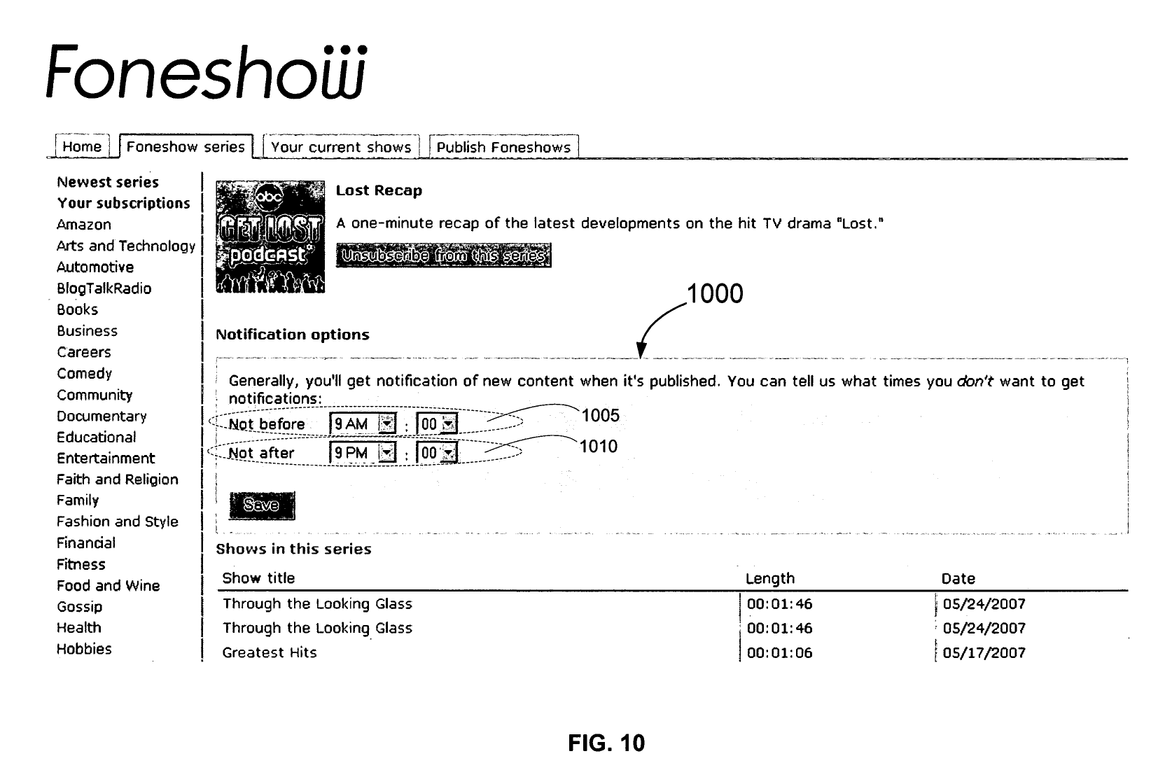

Because the software 75 polls the searchable storage repository 84 and even polls content provider databases 125 for new pieces of audio content 315 in a series 910, text messaged DID numbers 305 may arrive at a registered mobile telephone 50 at any time. To prevent receipt of SMS messages at undesirable times, a user may register for receipt of new pieces of audio content 315 at certain desired frequencies or intervals. For example, the embodiment of the present invention depicted in FIG. 10 demonstrates a means for establishing times of desired inactivity. The website hosted by the web server 90 provides an interval selection box 1000 that enables a registered user to select a daily start time 1005 and a daily end time 1010 so that SMS messages containing embedded DID numbers 305 will arrive only within the window of time specified.

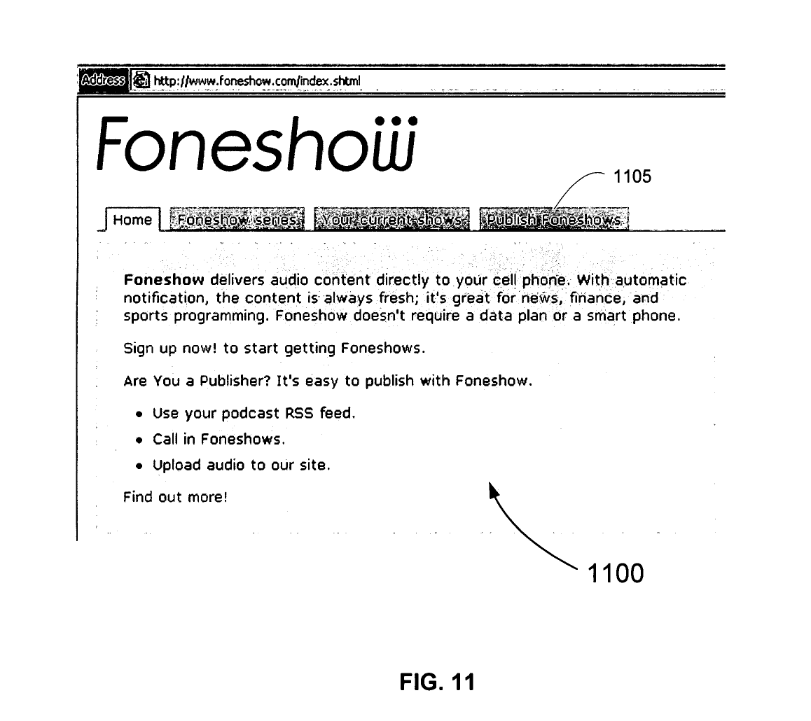

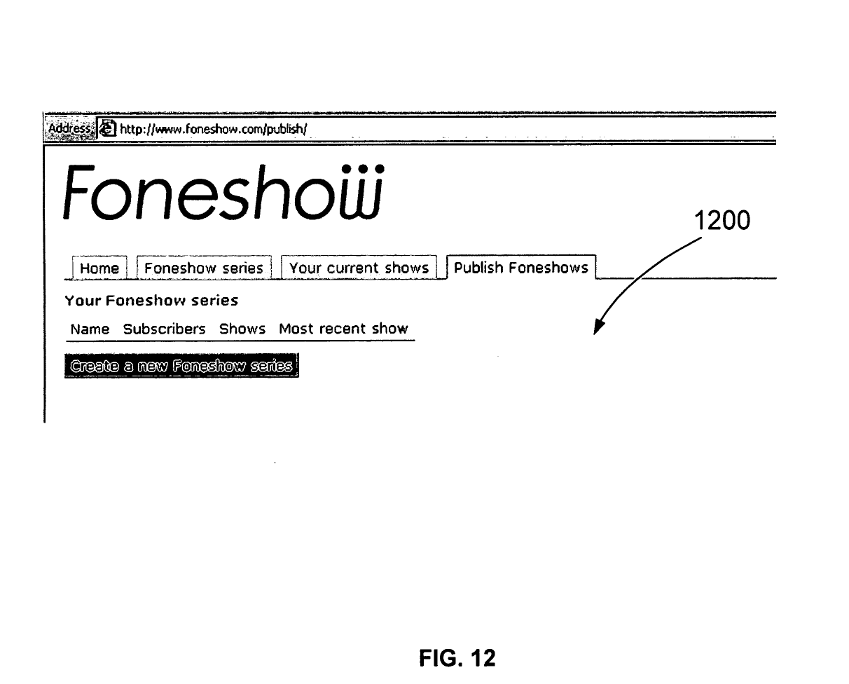

The plurality of pieces of audio content 315 stored in the searchable storage repository 84 and in the one or more additional audio storage servers 120a, 120b, 120c may originate from any number of sources, as highlighted by the text 1100 of FIG. 11. The website hosted by the web server 90 enables publishers to add pieces of audio content to the searchable storage repository 84 and one or more additional audio storage servers 120a, 120b, 120c. Clicking on a “publish foneshows” tab 1105 will bring a publisher to a publication page 1200, depicted in FIG. 12.

A publisher may upload digital audio content directly, or a publisher may link a really simple syndication (RSS) feed to the searchable storage repository by registering that link through the web server 90. The system 10 of the present invention then will poll the RSS feeds for updated pieces of audio content 315. The present invention thus provides a mechanism for updating podcast content for delivery to a plurality of registered users. The application server 85 of the present invention further comprises typical computing means, such as a memory portion 70, a processor 65 and executable software 75 containing instructions for transcoding audio content into digitized content suitable for playback over telephony devices. For example, in one embodiment, the application server 85 will transcode .mp3 type podcasts into a flat format, for example, a 16 bit, 8 kHz wave. The application server 85 will store the transcoded pieces of audio content 315 to the searchable storage repository 34 and one or more additional audio storage servers 120a, 120b, 120c for later retrieval by the telephony server 95. This saves the telephony server 95 from having to convert and reformat pieces of audio content 315 at playback time.

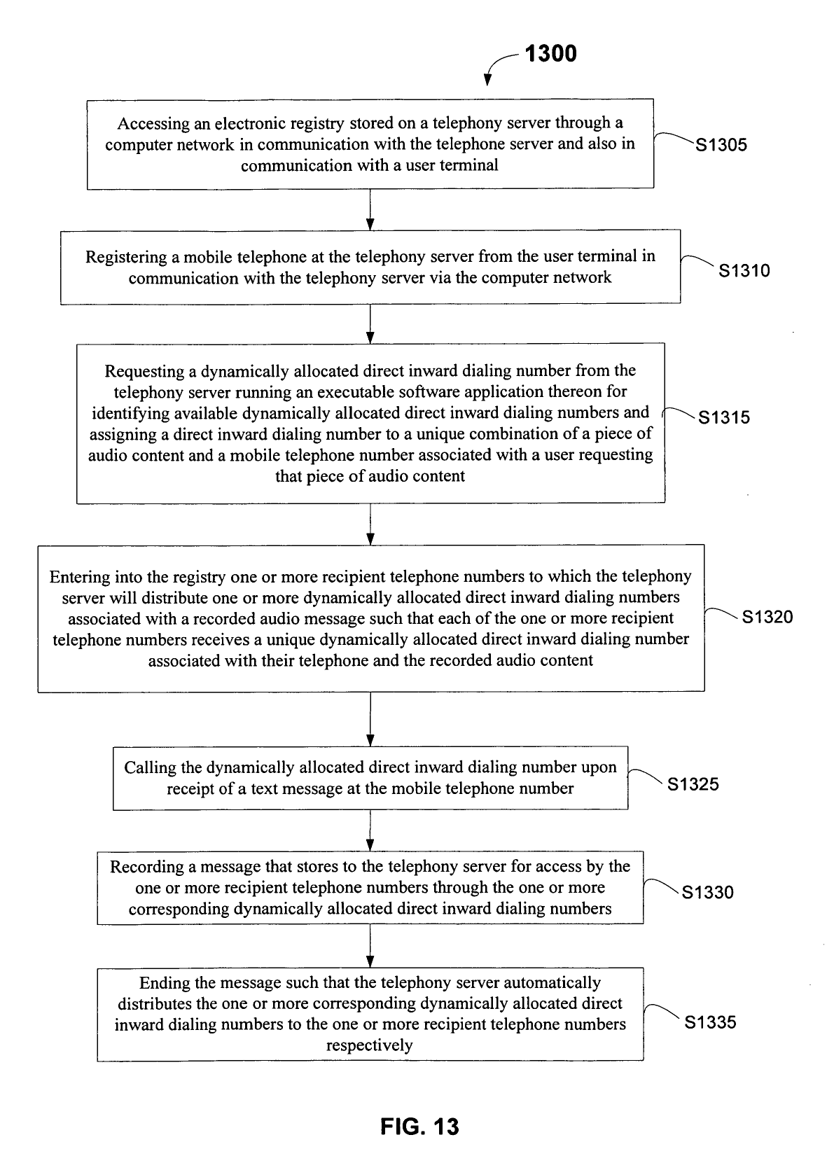

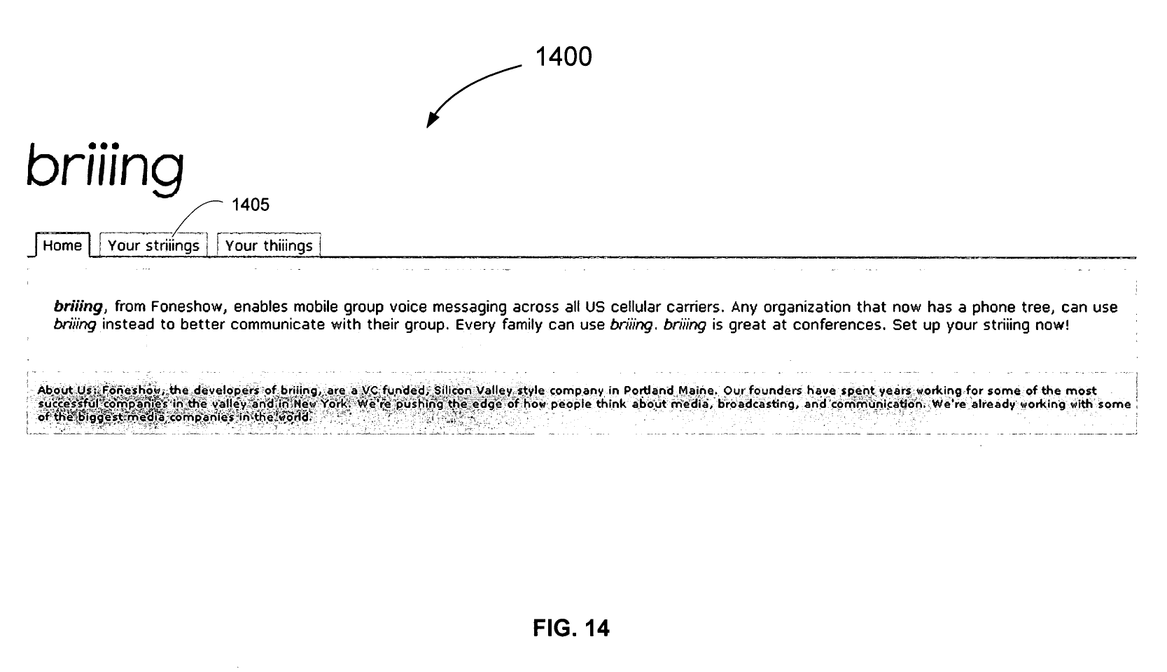

In addition to originating from RSS feeds and audio uploads, pieces of audio content 315 may originate from audio recorded to the searchable storage repository 34 by a registered user. FIGS. 13 through 17 depict a method and system for recording pieces of audio content 315 to the searchable storage repository for distribution to one or more recipient mobile telephone numbers 310 entered into the registry 32 and cross-indexed with the recorded pieces of audio content 315. FIG. 13 demonstrates the method of recoding audio content 1300. A first step S1305 comprises accessing the registry 32 and a second step S1310 comprises registering a mobile telephone number with the system 10 as described above with regard to FIGS. 5a through 5c. Through the website hosted by the web server 90, a user may access a recording webpage 1400 shown in FIG. 14 that appears as a graphical user interface on one of the plurality of user terminals 20. The recording webpage provides interactive entry forms for executing a third method step S1315 comprising requesting DID a number 305 to which a user will record audio content and a fourth method step S1320 comprising entering into the registry 32 one or more recipient mobile telephone numbers 310.

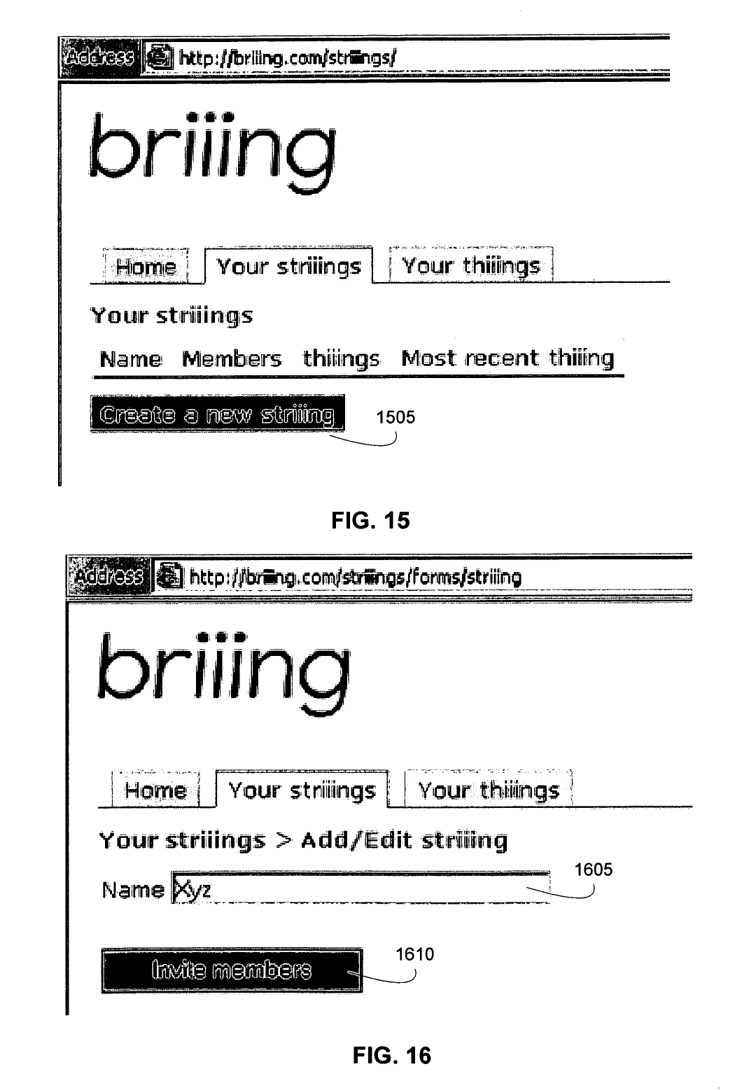

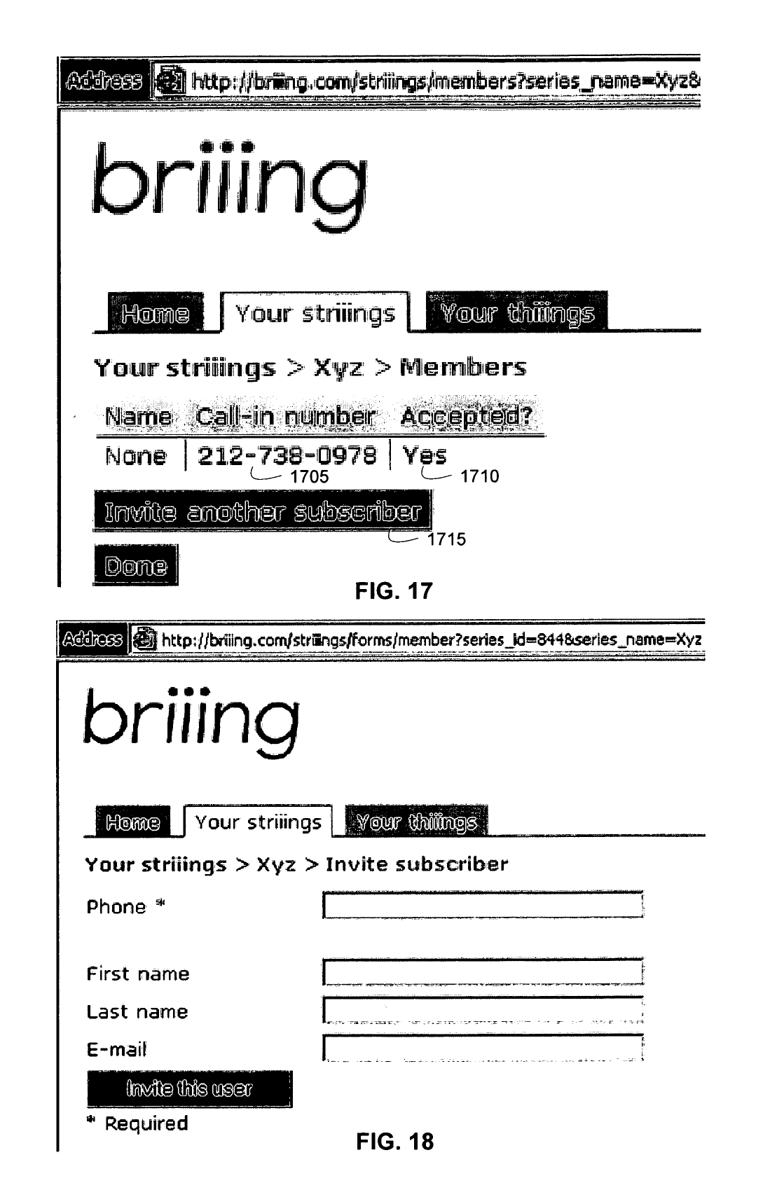

In one embodiment, clicking on a “your striiings” tab 1405 leads to the interactive data entry screens of FIGS. 15 through 20. The screen depicted in FIG. 15 enables a registered user to select a “create a new striiing” button 1505, and the screen depicted in FIG. 16 enables a user to enter a name 1605 representing the piece of audio content 315 that the user will record to the registry 32. Selecting an invite members button 1610 leads to the data entry screen of FIG. 17 which presents a call-in number 1705, i.e. a uniquely assigned DID number 305, associated with the registered user establishing the piece of audio content 315, and a default accepted status identifier 1710. The user will receive this call-in number 1705 as embedded text in an SMS message automatically delivered to the registered mobile telephone number 310 by the telephony server 95. The user may call this call-in number 1705 to record a piece of audio content 315 to the searchable storage repository 34. Accordingly, a fifth step S1325 of the present method 1300 comprises calling the dynamically allocated DID number 305 upon receipt of a text message at the mobile telephone 50 associated with the registered mobile telephone number 310, and a sixth step S1330 comprises recording a message to the searchable storage repository 34.

Selecting an “invite another subscriber” button 1715 enables a user to enter into a data entry form depicted in FIG. 18 an option name, a required mobile telephone number 310 and optional email address for one or more recipients of the piece of audio content 315. The system 10 automatically will assign a unique DID number 305 to the recipient of the recorded piece of audio content so that the recipient may call the unique DID number 305 assigned to his mobile telephone number 310 and hear automatic playback of the recorded audio message. The user also may invite additional recipients to hear playback of the recorded message by again selecting the “invite another subscriber” button 1715.

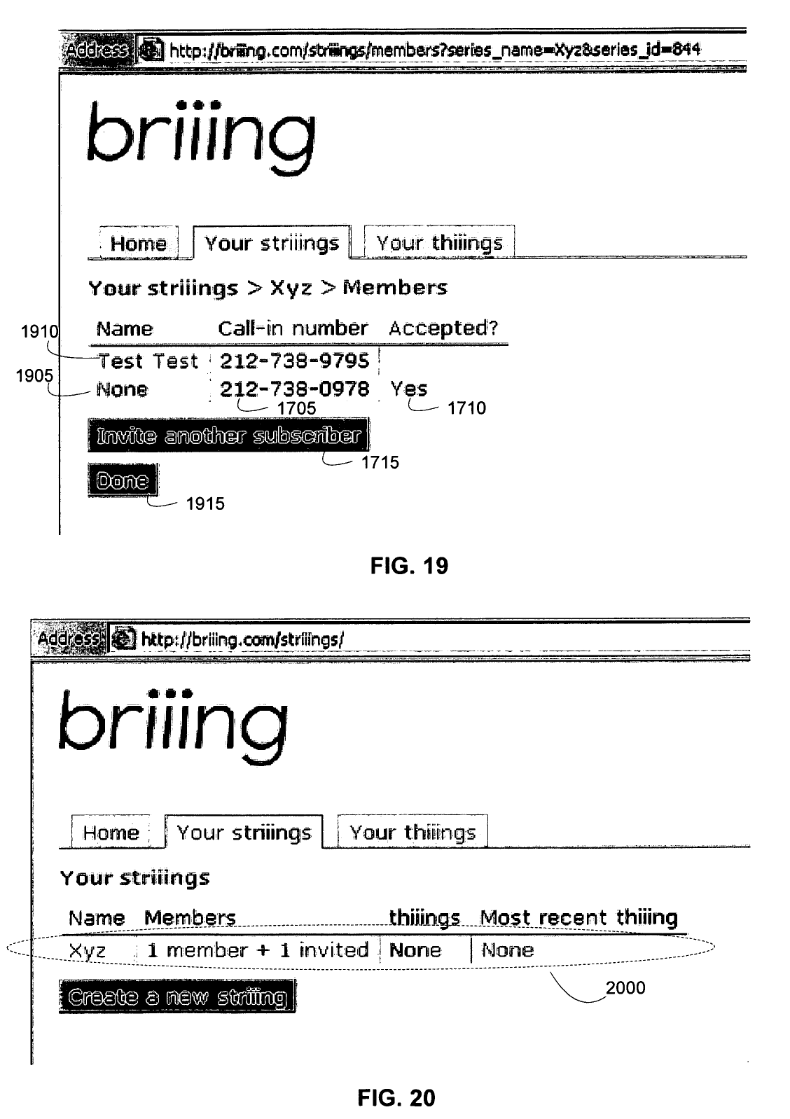

As described above with regard to FIG. 3, the system 10 assigns each DID number 305 uniquely in a tripartite combination also comprising a unique mobile telephone number 310 and a particular piece of audio content 315, here a recorded message. As FIG. 19 depicts, a piece of audio content 315 named “Xyz” links with two users, an unnamed registered user 1905 recording the audio content and a recipient 1910 named “Test Test.” Each of these group members receives a separate DID number 305, or call-in number 1705, embedded in a text message such that they may separately call their assigned call-in numbers 1705 to hear playback of the recorded piece of audio content 315 at any time convenient for each of them. When a user finishes recording a message and inviting users, the user selects a “done” button 1915 and a summary 2000 of the recorded message and number of recipients appears on the graphical user interface of the user terminal 20, as depicted in FIG. 20. A seventh and final step S1335 comprises ending the recordation of a message by hang-up the mobile telephone 50 and thereby prompting the telephony server 95 to automatically distribute the uniquely assigned dynamically allocated direct inward dialing numbers 305, i.e. call-in numbers 1705, to the one or more recipient mobile telephone numbers 310.

Additionally, a recipient of a recorded piece of audio content 315 may select a playback command for recording a reply message. The telephony server 95 will receive this reply message and store that to the searchable storage repository 34 and add a link to that new reply message within the cross-index 300 in the registry 32. The telephony server 95 will distribute new DID numbers 305 to each member associated with the original string such that each member may call their uniquely assigned DID number 305 from their unique mobile telephone number 310 and hear playback of the recorded reply message. Lastly, this content creation method 1300 and the other content creation methods enable a content creator to prevent recipients from forwarding a piece of audio content 315. The system 10 of the present invention enables a content creator to elect for a piece of audio content 315 to delete from the either the searchable storage repository 34 and/or the one or more associations in the cross-index 300 after a recipient has dialed in and listened to playback of the piece of audio content 315.

In addition to tracking data relations in a cross-index 300, the software 75 of the system 10 of the present invention comprises executable steps for tracking and presenting metrics associated with the pieces of audio content 315. For example, a user who records a piece audio content 315 for a plurality of recipients, such as a campaign leader providing a time sensitive message to campaign volunteers out knocking on doors, might want confirmation of receipt and confirmation that each recipient has listened to play back of the recorded piece of audio content 315. The present invention provides usage tracking and monitoring, enabling a content provider to track whether or not a recipient user has listened to piece of audio content 315 partially or completely. This tracking provides usage data regarding specific pieces of audio content 315, including both specific shows and specific series, assigned to each separate mobile telephone number 310. For example, the present invention may track metrics comprising whether a user hung up in the middle of playback, clicked on another piece of audio content 315 during playback, or forwarded a piece of audio content 315 to another mobile telephone number 315.

It is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

We claim:

1) A computer implemented method for providing playback of audio content to one or more mobile telephone users comprising:
a) providing a registry in communication with a computer network for receiving and storing user criteria for the one or more mobile telephone users, the user criteria comprising at least a mobile telephone number and a request for a piece of audio content;
b) providing a searchable storage repository also in communication with the computer network for receiving and storing a plurality of pieces of audio content for distribution to the one or more registered mobile telephone users;
c) providing a telephony server also in communication with the computer network that comprises a memory portion and a processor portion, wherein the memory portion contains therein a plurality of dynamically assigned direct inward dialing numbers and a software portion comprising steps executable by the processor, wherein the steps comprise:
i) identifying a requested piece of audio content on the searchable storage repository, and
ii) establishing a conduit to one of the corresponding pieces of audio content by cross referencing an available dynamically allocated direct inward dialing number terminating at the telephony server with both a requested piece of audio content and a requesting mobile telephone number;
d) receiving a request at the registry from a mobile telephone user for a specific piece of audio content;
e) assigning a dynamically allocated direct inward dialing number that terminates at the telephony server and uniquely identifies the combination of the requested piece of audio content and the requesting telephone number; and
f) text messaging the dynamically allocated direct inward dialing number to the registered mobile telephone user so that the registered mobile telephone user may call the dynamically assigned direct inward dialing number directly and listen to the requested piece of audio content.

2) The method of claim 1, wherein the piece of audio content is a single show in a series of related pieces of audio content.

3) The method of claim 2, wherein the request for a piece of audio content is a continuous request for new shows in a series of related pieces of audio content such that a new show arriving at the searchable storage repository triggers steps c) through f).

4) The method of claim 1, wherein the telephony server automatically identifies a mobile telephone number of the mobile telephone user calling a dynamically assigned direct inward dialing number and thereby automatically identifies the piece of audio content assigned to that dynamically assigned direct inward dialing number delivered to that mobile telephone number.

5) The method of claim 1, wherein the plurality of pieces of audio content may originate from an RSS feed.

6) The method of claim 5, further comprising transcoding audio content originating from an RSS feed into a format compatible with mobile telephony prior to storing the piece of audio content on the searchable storage repository.

7) The method of claim 1, wherein the plurality of pieces of audio content originate from a message called into the searchable storage repository over a telephone and delivered via a VoIP gateway.

8) The method of claim 1, wherein the plurality of pieces of audio content originate from a audio content uploaded over the computer network into the searchable storage repository.

9) The method of claim 1, wherein the requested piece of audio content originates from a recorded messaged added to the searchable storage repository by a registered mobile telephone user and creating the recorded message comprises the request for the piece of audio content.

10) The method of claim 9, further comprising receiving a plurality of mobile telephone numbers for one or more intended recipients of the recorded message and cross referencing an available dynamically allocated direct inward dialing number terminating at the telephony server with both the message recorded and a mobile telephone number for each of the one or more intended recipients such that each recipient receives a unique direct inward dialing number at their mobile telephone that maps to the recorded message.

11) The method of claim 1, further comprising step g) tracking information related to playback of the requested piece of audio content.

12) The method of claim 1, wherein the information tracked identifies whether or not a mobile telephone user listened to the entire requested piece of audio content.

13) The method of claim 1, step c) further comprising identifying which dynamically assigned direct inward dialing numbers are available for assignment to a requested piece of audio content.

14) The method of claim 14, wherein the dynamically assigned direct inward dialing numbers are reusable and expire in chronological order.

15) The method of claim 1, further comprising step g) providing dual-tone multi-frequency commands for interacting with the piece of audio content and/or series of related pieces of audio content during playback.

16) A method of using an electronic system for providing audio content to a recipient device, comprising:
a) logging in from a user terminal to an electronic registry stored on a service terminal in communication with a computer network also in communication with the user terminal;
b) requesting particular audio content stored in a searchable repository such that the request stores to the registry along with an associated identifier for the recipient device;
c) receiving a text message at the recipient device comprising a unique dynamically allocated direct inward dialing number that provides a conduit directly to the requested audio content; and
d) calling the number from the recipient device to initiate automatic playback of the requested audio content.

17) The method of claim 16, wherein the associated identifier is a mobile telephone number and the recipient device is a mobile telephone.

18) The method of claim 17, wherein the user terminal is the mobile telephone and the service terminal automatically identifies the mobile telephone number and stores that to the registry along with the request for audio content.

19) The method of claim 17, further comprising a step between steps a) and b) of entering a mobile telephone number into the electronic registry.

20) The method of claim 16, wherein the associated identifier is an electronic datum identifying an instant messaging client and the recipient terminal is a device running the instant messaging client.

21) The method of claim 16 wherein the text message comprises hyperlinked text selectable for automatically dialing the dynamically allocated direct inward dialing number.

22) The method of claim 16, wherein the request for audio content may be a continuous request resulting in one or more text messages each day that reflect updates of the audio content on the searchable repository.

23) The method of claim 22, further comprising registering the request with preferred intervals for receipt of the text message.

24) The method of claim 16, further comprising using keypad commands to control playback of the requested audio content during playback of the requested audio content.

25) A method of establishing audio content for distribution to a plurality of users comprising:
a) accessing an electronic registry stored on a telephony server through a computer network in communication with the telephony server and also in communication with a user terminal;
b) registering a mobile telephone at the telephony server from the user terminal in communication with the telephony server via the computer network;
c) requesting a dynamically allocated direct inward dialing number from the telephony server running an executable software application thereon for identifying available dynamically allocated direct inward dialing numbers and assigning a direct inward dialing number to a unique combination of a piece of audio content and a mobile telephone number associated with a user requesting that piece of audio content;
d) entering into the registry one or more recipient telephone numbers to which the telephony server will distribute one or more dynamically allocated direct inward dialing numbers associated with a recorded audio message such that each of the one or more recipient telephone numbers receives a unique dynamically allocated direct inward dialing number associated with their telephone and the recorded audio content;
e) calling the dynamically allocated direct inward dialing number upon receipt of a text message at the mobile telephone number; and
f) recording a message that stores to the telephony server for access by the one or more recipient telephone numbers through the one or more corresponding dynamically allocated direct inward dialing numbers; and
g) ending the message such that the telephony server automatically distributes the one or more corresponding dynamically allocated direct inward dialing numbers to the one or more recipient telephone numbers respectively.

26) The method of claim 22, further comprising accessing the telephony server from the user terminal to view information related to whether or not the users of the one or more recipient telephone numbers accessed some or all of the recorded message.

27) The method of claim 22, wherein the telephony server automatically identifies a mobile telephone number calling a direct inward dialing number and automatically cross references the mobile telephone number to the associated audio content related to the direct inward dialing number uniquely assigned to the combination of the mobile telephone number and the audio content.

28) A computer implemented method for providing playback of audio content to a plurality of mobile telephone users, comprising:
a) providing a computerized telephony server which can accept telephone calls made to any of a plurality of direct inward dialing (DID) numbers terminating at the telephony server;
b) storing in an audio repository available to the telephony server a plurality of items of audio content;
c) associating each DID number separately and uniquely with a unique combination of elements comprising:
i) a mobile telephone number associated with one of the plurality of mobile telephone users, and
ii) an item of stored audio content and/or a collection of related items of stored audio content;
d) storing the association of step c) in an association repository available to the telephony server;
e) delivering each uniquely associated DID number to the corresponding associated mobile telephone number;
f) receiving at the uniquely associated DID number terminating at the telephony server a telephone call from the corresponding associated mobile telephone number;
g) cross-indexing in the association repository the corresponding associated mobile telephone number from which the associated mobile telephone user is calling with the uniquely associated DID number that the associated mobile telephone user called;
h) retrieving from the audio repository an item of stored audio content assigned to the uniquely associated DID number; and
i) playing the item of audio content to the associated mobile telephone user.

29) The method of claim 1, further comprising a step between steps f) and g) for automatically identifying the corresponding associated mobile telephone number through an identification means.

30) The method of claim 29, wherein the identification means is ANI or Caller ID information included in data that automatically accompanies the telephone call originating from the corresponding associated mobile telephone number.

31) The method of claim 28, wherein a delivery method for step e) is a text message.

32) The method of claim 31, further comprising notifying the mobile telephone user by text message of the uniquely associated DID number when a new item of stored audio content is newly associated with their mobile telephone number.

33) The method of claim 32, wherein the new item of stored audio content is newly associated with the collection of related items of stored audio content.

34) The method of claim 33, wherein the new item of stored audio content is the most recent item of stored audio content in the collection of related items of stored audio content associated with the mobile telephone number and the uniquely associated DID number.

35) The method of claim 32, wherein the new item of stored audio content is newly associated with the mobile telephone user because another of the plurality of mobile telephone users requested that the telephony server forward a uniquely associated DID number linked to the mobile telephone number and the new item of stored audio content.

36) The method of claim 28, wherein the telephony server is in communication with a computer network also in communication with the audio repository and the association repository.

37) The method of claim 28, wherein the item of stored audio content and/or a collection of related items of stored audio content originates from an RSS feed.

38) The method of claim 38, further comprising transcoding audio content originating from an RSS feed into a format compatible with mobile telephony prior to storing the plurality of items of audio content in the audio repository.

39) The method of claim 28, wherein the item of stored audio content and/or a collection of related items of stored audio content originates as audio recorded by the plurality of mobile telephone users.

40) The method of claim 28, wherein the item of stored audio content and/or a collection of related items of stored audio content originates as data uploaded over the computer network to the audio repository.

41) The method of claim 28, further comprising a step between steps b) and c) for identifying an available DID number from among the plurality of DID numbers that terminate at the telephony server.

42) The method of claim 41, further comprising a step for reusing the DID number having the oldest association if all of the DID numbers that are already associated with the plurality of mobile telephone users and the plurality of audio content, and simultaneously erasing the oldest association from the association repository.

43) A system for playback of audio content to a plurality of mobile telephone users, comprising:
a) a repository containing a plurality of items of stored audio content;
b) a data store in communication with the repository and adapted to associate each of a plurality of direct inward dialing numbers (DIDs) separately and uniquely to each of a plurality mobile telephone numbers corresponding the one or more mobile telephone users, and assign to each DID association an item of stored audio content or a category of items of stored audio content; and
c) a computerized device comprising a processor portion, a memory portion and a software portion thereon comprising steps executable by the processor, wherein the steps comprise:
i) receiving a telephone call from each of the plurality of mobile telephone users each dialing a uniquely associated one of the plurality of DIDs,
ii) cross-indexing in the data store each of the plurality of mobile telephone numbers from which each of the plurality of mobile telephone users is calling with each of the plurality of DIDs called,
iii) retrieving from the repository the plurality of items of stored audio content assigned to each unique assigned DID; and
iv) playing the plurality of items of stored audio content to each of the plurality of mobile telephone users over each of the connected telephone calls made to the corresponding uniquely associated DIDs.
